(19) United States
(12) Patent Application Publication
(10) Pub. No.: US 2022/0055901 A1
(43) Pub. Date: Feb. 24, 2022

(54) PRODUCTION OF NITROGEN OXIDES

(71) Applicant: C-TECH INNOVATION LIMITED, Chester (GB)

(72) Inventors: Robert Stuart Ellis BELL, Chester (GB); Dom CUPERTINO, Neston (GB)

(21) Appl. No.: 17/299,444

(22) PCT Filed: Dec. 3, 2019
(86) PCT No.: PCT/GB2019/053419

§ 371 Date: Jun. 3, 2021

(30) Foreign Application Priority Data
Dec. 3, 2018 (GB) 1819684.0

(51) Int. Cl. C01B 21/20; C01B 21/24; B01J 19/12; B01J 19/08; B01J 19/00; B01J 19/14

(52) U.S. Cl. CPC C01B 21/203; C01B 21/24; B01J 19/14; B01J 19/087; B01J 19/0006; B01J 19/126

(57) ABSTRACT

A method and apparatus for the manufacture of nitric oxide and/or nitrogen dioxide in which a plasma is formed from nitrogen and oxygen passed through gas inlets into a reaction chamber to create a vorticular flow in the reaction chamber. A source of microwave energy is used to energise the nitrogen and oxygen in a microwave transparent inner plasma containment

### BACKGROUND OF THE INVENTION

### 1. Field of the Invention

This invention relates to a method and apparatus for the conversion of oxygen and nitrogen gases to form nitrogen oxides.

### 2. The Prior Art

The chemical fixation of nitrogen is an important industrial process in the manufacture of nitric acid, ammonium nitrate and other materials. Nitric acid is conventionally made by oxidising nitric oxide to nitrogen dioxide and then reacting this with water to produce nitric acid. Nitric oxide is conventionally obtained by means of the oxidation of ammonia produced in the Haber process. Plasma reactors have historically found use for the fixation of nitrogen for the manufacture of nitric acid which is an industrially useful chemical. The Birkeland-Eyde Process (1903) was used historically to produce nitric acid using an electric arc plasma but the conversion efficiency was low and the process was replaced by what is the now conventional production method for nitric oxide (NO) which involves catalytic oxidation of ammonia by air in the presence of catalysts such as platinum and rhodium.

Plasma processing has the potential inherent advantage over conventionally used chemical process in that it requires lower absolute pressures and temperatures to operate but it remains the case that its efficiency is too low. Significant research has therefore been carried over many years with the objective of improving the efficiency of nitrogen fixation with various types of plasma reactors (see for example FRIDMAN, A. Plasma Chemistry, Chapter 6, Cambridge University Press, 2008.) but none has so far achieved efficiencies enough to compete with modern industrial processes used in the manufacture of bulk chemicals.

WO 2012/150865 A (INGELS R) 08.11.2012 discloses a method for the direct production of nitrogen oxide using a moving electric arc plasma with additional adaptation to manage the temperature of the plasma. The method disclosed is adding a liquid water spray in order to reduce the local plasma temperature to below 2000° K. This patent also discloses the use of lower pressures of between 0.2 and 0.8 bar absolute to increase the yield of NO gas.

The Schönherr process developed by BASF, an improvement to the Original Birkeland-Eyde process, was shown to give higher yields of NO at higher pressure in the range of 80-200 mm Hg. BASF claims that operation at these higher pressures is better for the conversion to NO in a gliding arc plasma operation.

A method described in WANG, W, et al. Nitrogen Fixation by Gliding Arc Plasma: Better Insight by Chemical Kinetics Modelling (ChemSusChem 2017, vol. 10, p. 2145) describes improvements in the production of NO and NO₂ using a Glide Arc Plasma. In this study it was found that the highest concentration of NO and NO₂ is achieved for feed gas compositions close to the stoichiometric values around 50% N₂ and 50% O₂.

GB 2442990 A (C-TECH INNOVATION LIMITED) 23.04.2008 discloses a microwave plasma apparatus with vorticular or swirled gas flow that operates at relatively low temperatures and pressures.

In none of the processes developed to date is the efficiency enough to compete with established non-plasma methods of production. The methods disclosed require the use of ratios of oxygen and nitrogen other than that found in air and this has the consequence that the overall process is less efficient.

### SUMMARY OF THE INVENTION

According to a first aspect of the present invention a method of manufacturing nitric oxide and/or nitrogen dioxide comprises forming a plasma from nitrogen and oxygen as the reacting gases which are passed through one or more gas inlets into a first reaction chamber to create a vorticular flow in the reaction chamber, energising said nitrogen and oxygen in a microwave transparent first inner plasma containment cylinder by a microwave source to create a plasma.

In one implementation gases from the first reaction chamber flow to a second chamber downstream.

Usually the said second chamber having a microwave transparent inner containment cylinder through which the gases flow, in which the gases are energised by a second microwave source.

In such a two-chamber arrangement there is a connection between the chambers which is narrower than the diameter of the first inner plasma containment cylinder.

To prevent overheating, ideally gas flow through the reactor is maintained such that the residence time in the inner plasma containment cylinder is less than 10 seconds.

This vorticular flow of allows for a stable containment of the plasma without overheating the microwave transparent plasma containment cylinder. This is important because if the plasma containment cylinder overheats then its dielectric properties change and it begins to absorb microwave energy and thermal runaway may occur.

The plasma is sustained by the transfer of kinetic energy from electrons that have been accelerated by the microwave field to other species present within the plasma. The extent of the plasma is a function of the shape of the plasma containment cylinder and rate of gas feed and the microwave power applied.

In another aspect of the invention apparatus for facilitating a chemical reaction between nitrogen and oxygen, comprises a first reaction chamber, inlets for reacting gas(es) arranged to create a vorticular flow in the reaction chamber, a first microwave transparent inner plasma containment cylinder and a microwave source arranged to direct microwaves at the inner containment cylinder to create a plasma.

In a development of the apparatus, the reaction chamber has an outlet connected to inlet of a second reaction chamber having a further inner plasma containment cylinder with a further microwave source arranged to direct microwaves at the second inner containment cylinder.

It has been found surprisingly that a vortex microwave plasma system can be operated effectively at high ratios of nitrogen to oxygen, between 50% and 90% nitrogen including at the ratio in air. This is advantageous in any industrial process because it avoids the need to enrich the feed gas with oxygen. Furthermore, the vortex microwave plasma enhanced conversion is possible at pressures significantly above atmospheric pressure which allows for increased production rate and consequently increased plant capacity. It has also been found that mixing the formed plasma with additional reagents downstream from the plasma chamber can promote higher yields and stabilise the formed nitrogen oxide, said reagents consisting primarily of oxygen and nitrogen. An increase in the conversion efficiency was also found when a proportion of the feed gas to that plasma system was substituted for an inert gas stream.

In a preferred arrangement an auxiliary cooling gas stream is introduced into the formed plasma flow or plume. The cooling gas serves to cool the plasma and help quench any back-reactions thereby improving the efficiency of the process.

The frequency of the microwave radiation used to generate the plasma may be one of the available frequencies being either or 896 MHz or 900 MHZ or 915 MHz or 2450 MHz. The process and equipment can be operated over a range of pressures from 20,684 Pa (3 psi) to 2068,000 Pa (300 psi). A pressure controller may be located on the outlet of the reactor.

The method provides a more energy efficient chemical conversion than other plasma techniques. The microwave energy input couples primarily with the dissociated electrons in the plasma and not with the other ions and molecules present so that it may be described as a non-equilibrium plasma. The result is that relatively less input energy is needed to achieve the required reaction conditions than is needed in other plasma technologies such as arc or glide arc plasmas. The thermally excited electrons transfer their kinetic energy to other species present which may be charged and or radical species. Energized electrons thereby generate other short lived and reactive species such as excited molecules or radicals at high energy states. The formation of these reactive species means that the activation energy needed to achieve conversion to the desired end products is reduced and the total energy required to produce the end product is less than that required using conventional techniques.

Additional reagents including gases and liquids and solids may be introduced into the gas input flows either upstream of the plasma chamber or downstream of it. Reagent supply assemblies may comprise one or more reagent inlets each connected to a supply of reagent and with a flow controller. The flow rates of the various gas feeds may be controlled independently.

In a further embodiment of the invention a second vortex plasma chamber containing a catalyst and catalyst support structure over which the plasma flows may be located immediately after the first plasma chamber so that the plasma passes from the first chamber into the second. This second microwave chamber is also provided with a microwave power source. One or more additional reagents may be introduced directly into the second catalyst reaction and not via the first reaction chamber. The plasma flow is directed across the catalyst surface and the stream of activated species increases the rate of normal catalytic processes. Catalysts may be supported on porous or non-porous plates, honeycombs, foams and granular materials. The support materials may be permeable or non-permeable and may be ceramics. The catalysts may also be monolithic or coated onto a monolithic support or applied as a coating to other articles such as beads or pellets.

Catalysts are selected depending on the type of chemical reaction for which they are active. Common examples of industrial heterogeneous catalysis involve gases being passed over the surface of a solid, often a metal, a metal oxide or a zeolite and the plasma reactor described here can be used with this type of catalyst. Examples include iron, nickel, zeolites, transition metal oxides, platinum and rhenium on alumina, vanadium (V) oxide on silica and platinum and rhodium and other oxide materials.

### BRIEF DESCRIPTION OF THE DRAWINGS

FIG. 1 is a cross section of a system suitable for use in the present invention;

FIG. 2 shows a schematic cross section of the microwave plasma generator of FIG. 1; and

FIG. 3 shows a simplified apparatus used to carry out experiments to analyse the effectiveness of the invention.

### DETAILED DESCRIPTION OF THE PREFERRED EMBODIMENTS

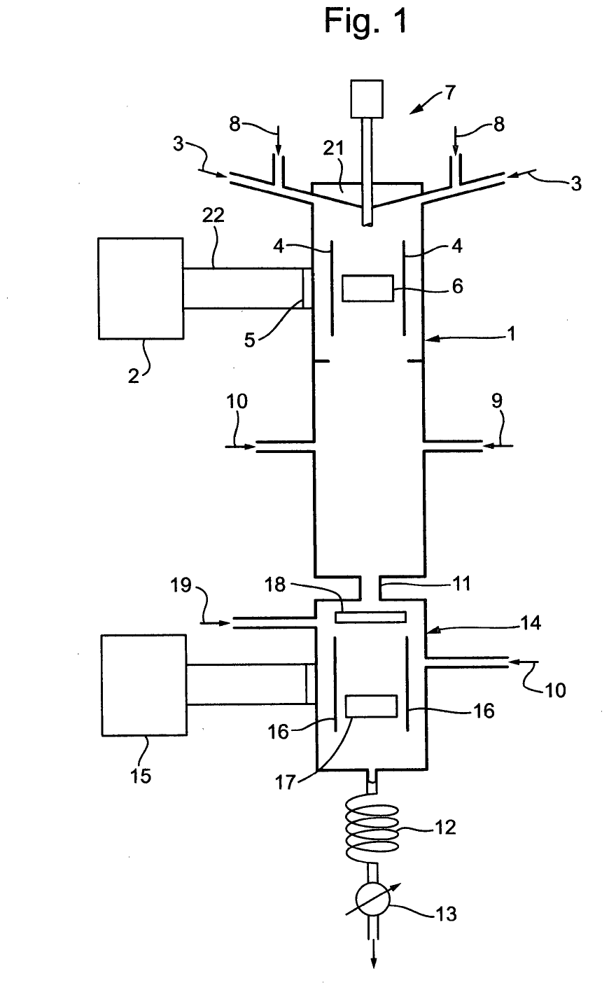

FIG. 1 shows a cross-section of the principal components of a system used with the present invention including an optional catalyst chamber and additional reagent ports. A first plasma reaction chamber 1 is provided with a source of microwave radiation 2 via a waveguide, 22. The microwave field extends throughout the chamber 1. The microwave source may be continuous or pulsed in its operation. The diameter of the plasma reaction chamber is preferably between the multiples of 0.5 and 1.5 of the wavelength in free space of the microwave source so that different microwave frequencies need to be matched to chambers of different sizes.

Feed gas or gases enters the top of the reaction chamber through ports, 3. These ports are at an angle to a plane across the top of the reactor vessel of up to 30°, typically around 15°. The tangential and downward cant of the gas feeds gives rise to a vorticular flow within a first inner plasma containment cylinder 4 which is of a microwave transparent material such as quartz. Microwave radiation is contained with the metallic reactor chamber 1 which includes a microwave transparent aperture 5 at the microwave inlet.

The feed gas or gases may additionally contain a gas that reduces the ionisation potential of the plasma. Suitable gases to reduce the ionisation potential include Ar, Ne, He and CO₂.

All gas inlets and outlets are of dimensions such that they function as microwave chokes. A microwave impervious viewing port 6 may be provided to allow the plasma to be monitored visually. A plasma ignition device 7 is used to light the plasma on start-up.

Additional reagents may be added in the gas feeds 8. Flow for all gas feeds may be achieved by means of mass flow controllers, rotor flow controllers, rotor meters, valves or any other type of flow control.

Auxiliary cooling gas, 9, is introduced into the plasma plume. One auxiliary cooling gas inlet is shown for simplicity, but typically multiple inlets are arranged around the circumference of the reaction chamber. The cooling gas could typically cool the plasma plume to below 1000K. Normally the auxiliary gas flow is supplied in a range between 5% and 70% of the total gas flow.

Additional reagents, 10, may also be added into the plasma plume.

The plasma leaves the first reactor chamber 1 an outlet 11. The diameter of the outlet 11 may be smaller than the diameter of the inner plasma containment cylinder 4 to cause a directed jet of plasma to leave the first reaction chamber 1 or it may be as wide as the chamber itself so that the plasma plume flows uninterrupted into the next vessel. A cooling device, 12, cools the gas flow to a temperature suitable for subsequent downstream processing. A pressure regulator, 13, regulates the pressure within the first reaction chamber 1.

An optional second reaction chamber 14 is provided with an second, but optional, optional microwave supply, 15, and a second plasma containment cylinder, 16. If there is no second microwave supply, this containment cylinder can be metallic The cylinder 16 contains one or more catalysts 17 supported on catalyst support structures, with the second plasma containment cylinder 16 directing the gases entering the second chamber towards the catalysts. Catalysts may be incorporated into suitable structures by methods including but not limited to chemical vapour deposition, sputtering, spray coating, and wash-coating. The plasma flow is optionally distributed by a spreader plate or similar device, 18. The purpose of this device is to distribute the plasma evenly across the catalyst surface thereby avoiding hot spots. Additional reagents may be introduced directly into the catalyst reaction chamber, 19.

Although the catalysts are here described as being in the second reaction chamber, they could be mounted in the first reaction chamber, with the first inner plasma containment cylinder 4 directing the plasma formed therein towards the catalysts.

The pressure regulator 13 would normally be placed downstream of the second reaction chamber, if a second reaction chamber is provided.

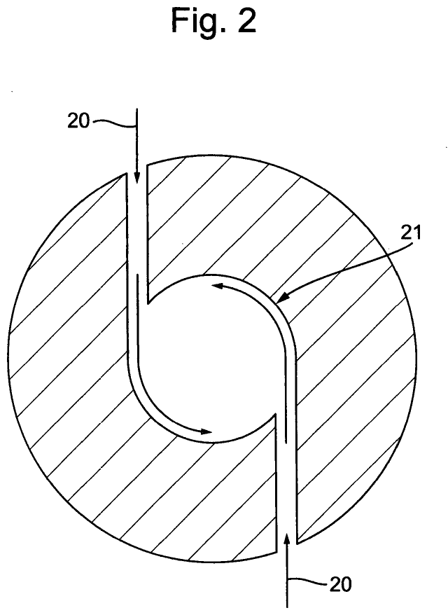

A plan view of the gas feed to the reactor vessel is shown in FIG. 2. Gas inlets 20, from ports 3 in FIG. 1, are arranged substantially tangential to the inner curved surface of the section passage 21 which forms the upper part of the reaction chamber 1. The arrangement of inlets is designed to cause the gas to flow in a swirling or vorticular fashion. Two inlets 3 are shown but can one if air alone is used, or more.

In operation, a small amount of plasma-forming gas, including oxygen and nitrogen, is introduced into the plasma containment cylinder 4, the microwave supply activated, and the electric ignition device operated so that a plasma is initiated. Once the plasma is initiated the flow rate of feed gas is increased. Other means of initiating the plasma may be used including employing a reduced pressure that causes a spontaneous ignition occurs or using a graphite electrode that is temporarily inserted into the plasma confinement.

As well as the reacting gases and auxiliary gas supply one or more additional reagents may be introduced. The number and location of these inlets will be determined by the specific requirements of the reaction being carried out. In an apparatus not intended for a specific reaction there may be many reagent inlets in order to provide maximum flexibility to allow for different reaction requirements.

### Specific Example

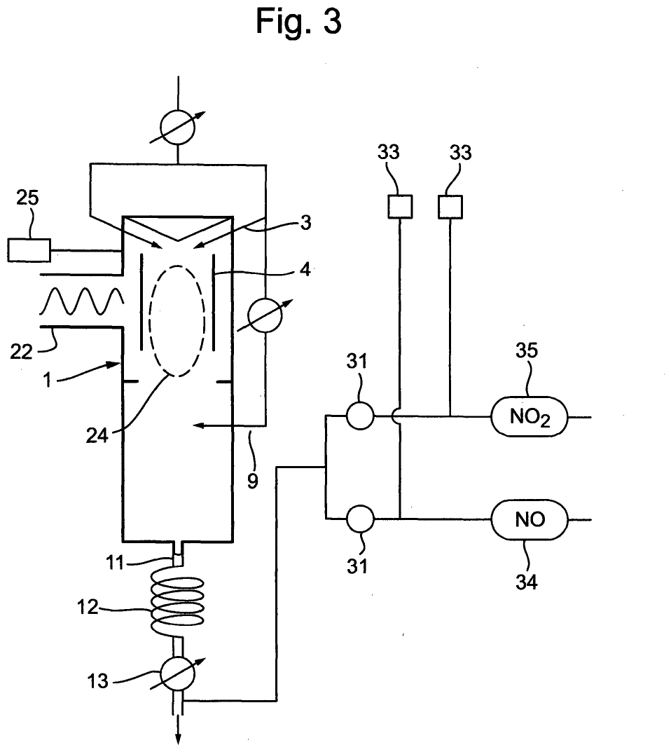

In this example a microwave plasma chamber 1 is used for the purposes of the formation of oxides of nitrogen, NOx, including nitric oxide and nitrogen dioxide. A second catalyst reactor chamber is not used in this example. The arrangement of the equipment is shown in FIG. 3. A 2.45 GHz 6 kW microwave generator is used. The diameter of the exit nozzle (choke) from the plasma reaction chamber 1 is adjustable. The reaction chamber length can be changed by incorporating additional sections. The reaction reactor 1 is equipped with auxiliary gas inlets at points 9 on the wall of the reactor vessel.

The reaction reactor 1 can operate at pressures from atmospheric to 4 bar gauge, although it is best operated above atmospheric pressure. When operating above atmospheric pressure a cooling coil is fitted 12 between the reactor outlet 11 and the back pressure regulator 13 in order to prevent heat damage to the pressure regulator 13. The pressure regulator is adjusted by reference to the pressure senor 25 connected to the wall of the plasma chamber 1.

Air or nitrogen and oxygen separately is/are fed to the chamber 1 through inlets 3 arranged as described in FIGS. 1 and 2. A source of microwave radiation is directed towards the inner plasma containment cylinder 4 though a waveguide 22 as shown in FIG. 1.

A small amount of air or nitrogen and oxygen is introduced into the plasma containment cylinder 4, the microwave supply activated and an electric ignition device (omitted in FIG. 3 for clarity but shown as 7 in FIG. 1) operated so that a plasma 24 is initiated. Once the plasma 24 is initiated the flow rate of air is increased.

It is convenient to express the efficiency of the conversion of nitrogen and oxygen in the feed air to NOx in terms of the amount of nitrogen flowing through the reactor that is converted into product (fixed nitrogen) per unit of energy used. For an industrial process, this is usually expressed as the amount of energy consumed in megawatt hours per unit of fixed nitrogen. This energy efficiency is calculated using the forward energy input of microwave power in kW, the NO concentration generated in ppm, the NO₂ concentration generated in ppm and the gas flow volume in litres corrected to normal temperature and pressure of 1013.25 mbar and 20° C.

In order to optimise the conversion efficiency different choices of variable parameters are possible. In order to minimise the energy input for a given NO concentration the applied power, pressure and mass flow can be adjusted in order to give the optimal conditions for plasma formation and thereby the production of excited state precursors for NO formation. In practice it is found that the highest NOx conversion levels are achieved at lower pressures. An alternative approach is to increase the rate of NOx production for a given energy input by increasing the mass flow for a given energy input. The increased mass flow rates require increased operating pressures in order to maintain a stable plasma. For an optimum industrial process there is a compromise between efficiency and throughput.

In the experiments described below the variable parameters were gas composition (N₂:O₂ ratio), gas flow rate, microwave power input, the addition of auxiliary (cooling) gas and the operating pressure.

The composition of the product gas stream was determined using electrochemical sensors. The product stream was sampled using pumps 31 and diluted with air inputted through air filters 33 through dilution pumps to provide a constant flow rate over each sensor 34 (for NO) and 35 (for NO₂) and at a level within the calibrated detection range. The sensors used were for NO, NO-AE 0-5000 ppm, and for NO₂, NO₂-AE 0-200 ppm, and were factory calibrated. Flow rates over each sensor were between 300-500 ml/min. The sensor calibrations were checked using certified calibration gases.

### Experiment 1

The effect of feed gas composition on NOx production at atmospheric pressure

A simplified reaction of nitrogen and oxygen can be written:

N₂+O₂ [symbol] 2NO and 2NO+O₂ [symbol] 2NO₂

On a molar basis it is therefore expected that higher yields of NOx product would be expected by increasing the % of oxygen in the reactant mixture and previous work (ChemSusChem 2017, 10, 2145-2157) has reported that higher yields of NOx can be obtained using approximately equimolar ratios of nitrogen to oxygen.

NOx production was measured at a fixed gas flow rate (24 l/min) and using a fixed continuous MW power input (4.0 kW) was investigated while varying the N₂:O₂ ratio.

The readings for both NO and NO₂ are shown in the table below.

TABLE 1

| N₂:O₂ ratio | NO | NO₂ | NO + NO₂ |
|---|---|---|---|
| 5 | 40760 | 6683 | 47443 |
| 3 | 37880 | 10024 | 47409 |
| 2 | 39390 | 8047 | 47437 |
| 1 | 33866 | 8611 | 47477 |

The results show that the total concentration of NOx produced is rather insensitive to the nitrogen to oxygen ratio and that it decreases at the lowest nitrogen to oxygen ratio tested. This is a surprising result and shows that good efficiencies can be achieved by using air without the need to enrich it with oxygen. This is important for industrial applications since the additional energy required to alter the gas composition from that of air can be avoided.

### Experiment 2

The effect of continuous power level input on the energy efficiency for NOx production at atmospheric pressure

Operation of the plasma at atmospheric pressure was carried out in order to determine the efficiency of the MW plasma. The NO/NO₂ production was studied using different gas flow rates between 25 and 301/min. The microwave input power was chosen as 3.5, 4.0 or 4.5 kW. The data collected are shown in the table below.

TABLE 2

| | | | | Energy |
|---|---|---|---|---|
| | Forward | | Total | efficiency |
| Total Flow | Power | NO + NO₂ | N fixed | (energy |
| l/min | (kW) | concentration | (rate) | per unit) |
| 25 | 3.5 | 39812 | 43.6 | 100.6 |
| 25 | 4.0 | 43369 | 45.3 | 105.5 |
| 25 | 4.5 | 47277 | 46.3 | 108.9 |
| 30 | 3.5 | 38293 | 38.1 | 87.1 |
| 30 | 4.0 | 41881 | 39.0 | 91.1 |
| 30 | 4.5 | 46331 | 39.1 | 92.6 |

The results show that for a given energy input the best energy efficiency is obtained at the higher flow rate.

### Experiment 3

The effect of gas flow rates, quenching air and pressure on the energy efficiency for NOx production

Auxiliary (quenching) air was introduced via four radially spaced ports in the wall of the reactor vessel at a ratio of approximately 1:2 vs the inlet air. A copper cooling coil was fitted between the outlet of the reactor and the back-pressure regulator valve. The continuous microwave power and gas flow rates were varied. Gas flow rate and pressure are not independent variables. The results are in the table below.

TABLE 3

| Total feed | | | | | |
|---|---|---|---|---|---|
| (feed + | | | | | Energy |
| quench air) | | Forward | | Total N | efficiency |
| at NTP | Pressure | Power | NO + NO₂ | Produced | (energy |
| (l/min) | (bar) | (kW) | (concentration) | (rate) | per unit) |
| 102 | 1.1 | 2.98 | 24274 | 86.6 | 34.4 |
| 110 | 1.3 | 3.15 | 22758 | 88 | 35.8 |
| 114 | 1.5 | 2.98 | 22409 | 89.2 | 33.4 |
| 123 | 1.9 | 4.00 | 26363 | 113.3 | 35.3 |
| 172 | 2.4 | 5.00 | 25921 | 155.6 | 32.1 |
| 173 | 2.5 | 5.95 | 28942 | 175.2 | 34.0 |

The results show that when using an auxiliary gas-feed the production rate can be increased at approximately equal efficiencies by simultaneously increasing the gas flow rate, applied pressure and applied power.

In the apparatus shown, normally the power density is between 0.3 Wcm-3 and 1 Wcm-3 and the pressure in the microwave cavity is maintained between 1.1 bar abs and 5 bar abs.

1-31. (canceled)

32. A nitric oxide and nitrogen dioxide manufacturing apparatus comprising:
a first reaction chamber;
a first set of inlets for introducing reacting gases into the first reaction chamber arranged to create a vorticular flow in the first reaction chamber, wherein the reacting gases are nitrogen and oxygen; and
a first microwave-transparent inner plasma containment cylinder disposed within the first reaction chamber and a first microwave source arranged to direct microwaves at the first microwave-transparent inner plasma containment cylinder to create a plasma.

33. The apparatus according to claim 32, in which the microwaves have a wavelength in free space, and the first reaction chamber has a diameter which is between multiples of 0.5 and 1.5 times the wavelength in free space.

34. The apparatus according to claim 32, further including a second reaction chamber having a second inlet, the first reaction chamber having an outlet connected to the second inlet so that the gases flow in a downstream direction from the first reaction chamber flow into the second reaction chamber.

35. The apparatus according to claim 34, in which the second reaction chamber has a second microwave-transparent inner plasma containment cylinder and, in use, the gases flow into the second microwave-transparent inner plasma containment cylinder.

36. The apparatus according to claim 35, further including a second microwave source arranged to direct microwaves at the second microwave-transparent inner plasma containment cylinder.

37. The apparatus according to claim 35, further including a spreader disposed in the second reactor chamber between the second inlet and the second microwave-transparent inner plasma containment cylinder and wherein the gases flow from the second inlet over the spreader before passing into the second microwave-transparent inner plasma containment cylinder.

38. The apparatus according to claim 34, further including a passage having a smaller diameter than the first microwave-transparent inner plasma containment cylinder disposed between the first reaction chamber and the second reaction chamber, through which the gases pass.

39. The apparatus according to claim 35, wherein the second microwave-transparent inner containment cylinder contains one or more catalysts subject to microwave radiation.

40. The apparatus according to claim 35, wherein the apparatus further includes one or more reagent inputs, each having a flow controller, arranged to feed reagents into the gas flow upstream or downstream of the microwave-transparent inner plasma containment cylinders.

41. The apparatus according to claim 34, further including a cooler located downstream of the first reaction chamber.

42. The apparatus according to claim 34, further including a pressure controller located downstream of the first or second reaction chambers.

43. The apparatus according to claim 42, further including a cooler located downstream of the first reaction chamber and upstream of the pressure controller.

44. The apparatus according to claim 38, further including a cooler and a pressure controller located in the passage between the first reaction vessel and the second reaction vessel.

45. The apparatus according to claim 34, further including an auxiliary reagent gas supply feeding oxygen and nitrogen into the first reaction chamber downstream of the first microwave-transparent inner plasma containment cylinder.

46. The apparatus according to claim 34, further including an auxiliary cooling gas supply feeding into the first reaction chamber downstream of the first microwave-transparent inner plasma containment cylinder.

47. The apparatus according to claim 46, wherein the temperature of the gas leaving the reaction chamber is reduced to below 1000° K by the auxiliary cooling gas supply.

48. The apparatus according to claim 32, wherein the reacting gases comprise between 50% and 90% nitrogen.

49. The apparatus according to claim 32, wherein the reacting gases include air.

50. The apparatus according to claim 32, further including an inert gas feed into the first microwave-transparent inner plasma containment cylinder.

51. The apparatus according to claim 50, wherein the inert gas feed introduces a compound that reduces the ionization potential of the plasma, wherein the compound is selected from the group consisting of Ar, Ne, He and CO₂.
